(19) United States
(12) Patent Application Publication
(10) Pub. No.: US 2021/0301185 A1
(43) Pub. Date: Sep. 30, 2021

(54) Shaped Ceramic Abrasive Grain, Method for Producing a Shaped Ceramic Abrasive Grain, and Abrasive Article

(71) Applicant: Robert Bosch GmbH, Stuttgart (DE)

(72) Inventor: Holger Bausinger, Kreuzlingen (CH)

(21) Appl. No.: 17/262,078

(22) PCT Filed: Jul. 10, 2019
(86) PCT No.: PCT/EP2019/068494

§ 371 Date: Jan. 21, 2021

(30) Foreign Application Priority Data
Jul. 31, 2018 (DE) 10 2018 212 732.8

(51) Int. Cl. C09K 3/14; B24D 11/00; B24D 3/14; C04B 35/119; C04B 35/111

(52) U.S. Cl. CPC C09K 3/1409; B24D 11/001; B24D 3/14; C04B 35/119; C04B 2235/786; C09K 3/1436; C04B 2235/77; C04B 2235/785; C04B 35/1115

(57) ABSTRACT

A shaped ceramic abrasive grain, in particular based on alpha-Al₂O₃, includes two substantially parallel base surfaces with a polygonal base shape, said surfaces being connected by means of at least one stand surface, which is arranged substantially perpendicularly to the base surfaces, in order to position the abrasive grain on an abrasive article underlay. The abrasive grain has at least one cutting element which is arranged substantially opposite the at least one stand surface, wherein the cutting element includes at least one facet which is oriented obliquely to the base surfaces. The disclosure additionally relates to an abrasive article with abrasive grain and to a method for producing such abrasive grain.

The invention relates to a shaped ceramic abrasive grain, an abrasive article and also a process for producing a shaped ceramic abrasive grain.

### PRIOR ART

Shaped ceramic abrasive grains based on alpha-Al₂O₃ (alpha-aluminum oxide) are known from the prior art. Shaped abrasive grains are abrasive grains which have a defined shape and a defined size. The abrasive grains obtain their defined shape and defined size as a result of a defined shaping process. Thus, for example, various advantageous geometries for ceramic abrasive grains are described in WO 2014/020075 A1. Furthermore, unshaped or irregularly shaped abrasive grains, which are also referred to as broken abrasive grains, are known from the prior art. The advantage of shaped ceramic abrasive grains is their greater abrasive power compared to unshaped or irregularly shaped abrasive grains.

Two processes, inter alia, for producing shaped ceramic abrasive grains are known from the prior art; these are likewise described in WO 2014/020075 A1. As starting material for producing shaped ceramic abrasive grains, alpha-Al₂O₃ is known from the prior art. If alpha-Al₂O₃ is used as starting material, the slip process, in particular, is suitable for producing the abrasive grains. It is also known from the prior art that precursors of alpha-Al₂O₃ which are converted into alpha-Al₂O₃ during production of the abrasive grains can be used as starting material for the production process. Examples of suitable precursors are the aluminum oxide hydroxides boehmite (gamma-AlO(OH)) and diaspore (alpha-AlO(OH)) and also the aluminum orthohydroxides gibbsite (gamma-Al(OH)₃) and bayerite (alpha-Al(OH)₃). To produce the abrasive grains from these precursors, use is made of the sol-gel process which produces abrasive grains having a very fine microstructure.

There is comprehensive literature on the subject of shaped and partially shaped sol-gel abrasive grains. However, the starting material, alpha-Al₂O₃ or precursor of alpha-Al₂O₃, and the production process, sol-gel process or slip process, bring about significant differences in the behavior of the shaped ceramic abrasive grains produced therefrom.

Shaped ceramic abrasive grains having a triangular geometry which are fixed in a disordered orientation on an abrasive article substrate are known from the prior art. In addition, there are approaches to improving the abrasive action by fixing the abrasive grains in a preferably upright orientation, i.e. with an apex of the triangular abrasive grain shape pointing upward, on the abrasive article substrate in an otherwise (laterally) disordered orientation by means of electrostatic scattering, for example in DE 102013212670 A1. Finally, there are publications, for example in US 2013/0344786 A1, in which increasing the abrasive action by means of a defined (lateral) arrangement of shaped abrasive grains, in particular using templates or other aids, is described.

There continues to be a need in the abrasive industry to increase removal of material in the working of, in particular metallic workpieces further.

### DISCLOSURE OF THE INVENTION

The invention relates to a shaped ceramic abrasive grain, an abrasive article and also a process for producing a shaped ceramic abrasive grain.

“Essentially parallel main faces” means, in particular, that the deviation of the main faces from an ideal parallel arrangement is less than 35°, in particular less than 15°, very particularly preferably less than 5°. Furthermore, “essentially parallel” means that two planes which in each case approximate a main face and optionally average unevennesses present in the main face are parallel, i.e. their deviation from an ideal parallel arrangement is less than 35°, in particular less than 15°, very particularly less than 5°. As a result, relatively small depressions (dents, cavities or the like) or raised regions (bumps, points or the like) which could in principle be present in a main face have no or only little effect on the property of the essentially parallel main faces. Accordingly, the formulation “essentially parallel” encompasses abrasive grains which due to manufacturing tolerances can deviate slightly from the shape of an ideally shaped abrasive grain. In one embodiment of the abrasive grain, the spacing of the two main faces from one another is from 50 μm to 500 μm, in particular from 100 μm to 400 μm, very particularly from 150 μm to 300 μm. In a working example, this spacing is 240 μm. In this way, an abrasive grain which is flat can be indicated. A flat abrasive grain is considered to be an abrasive grain having a geometric body whose at least one main face and/or whose at least two main faces has/have an extension, in particular maximum extension which is a multiple of an extension, in particular maximum extension, between the two main faces. Thus, the ratio of extension of the at least one main face and/or the at least two main faces to the extension of the spacing between the main faces can, for example, be in a range from 2 to 10, in particular in a range from 2 to 5. For the purposes of the present invention, a face having “a polygonal geometry” is a face having at least three corners (or points), in particular having at least four corners, very particularly having at least five corners. In particular, a polygonal geometry can be rectangular or square, a polygon, in particular isogon, or partially angular and partially curved, for example partially round or ovally curved. In the geometric shape, one or more edges of the geometric shape can in principle be straight or curved. It may be pointed out that the specific configuration of the corners is not of any importance and that the corners can in principle also be rounded, with a radius of curvature being able to be not more than 30%, in particular not more than 20%, very particularly not more than 10%, of the length of the edge adjoining the rounding of the corner. In particular, this radius of curvature can be from 50 μm to 100 μm, in particular from 25 μm to 75 μm, very particularly preferably from 25 μm to 50 μm. In one embodiment of the abrasive grain, the polygonal geometry of a main face can also be multiple, i.e. have a rotational symmetry corresponding to the multiplicity (symmetrical around an axis of rotation oriented perpendicular to the main faces in respect of an angle of rotation of 360°/multiplicity). In one embodiment of the abrasive grain, the two main faces have the same number of corners. In an alternative embodiment of the abrasive grain, the two main faces have a different number of corners.

The main faces are joined by at least one standing face arranged essentially perpendicularly to the main faces for standing of the abrasive grain upright on an abrasive article substrate. The standing face thus forms a side face or side wall of the abrasive grain. Here, “essentially perpendicularly” means that a deviation of the angle between the standing face and the essentially parallel standing faces of 90° is less than 20°, in particular less than 10°, very particularly less than 5°. The formulation “essentially perpendicularly” accordingly encompasses abrasive grains which can, due to manufacturing tolerances, deviate slightly from the ideal shape of a shaped abrasive grain. However, it may be pointed out that this formulation does not include clearly oblique-angled geometries, i.e. in particular geometries having an angle which deviates by more than 20° from the ideal perpendicular arrangement. The standing face of the abrasive grain is configured so that the abrasive grain can in principle stand on this standing face without tipping over, in particular without further fixing by means of, for example, an adhesive or electrostatic attraction forces. In particular, in the case of an abrasive grain which has been stood up on an abrasive article substrate the projection of the center of gravity of the abrasive grain onto this abrasive article substrate is located within the standing face.

According to the invention, the abrasive grain has at least one cutting element which is arranged essentially opposite to the at least one standing face. The “cutting element” refers to a feature of the abrasive grain which is provided for exercising an abrasive action on a body to be ground, i.e. on a workpiece to be ground or to be worked. For this purpose, it is specifically designed so that a particularly high abrasive action can be achieved by means of the cutting element. In particular, this cutting element is, in the case of an abrasive grain standing upright on an abrasive article substrate, arranged essentially opposite to the standing face in such a way that during a grinding process it is suitable and provided for at least partly penetrating into the workpiece to be machined and thus displaying its abrasive action. “Essentially opposite” means that the at least one cutting element is arranged on the side which is, in particular, diametrically opposite the abrasive grain. In particular, the at least one cutting element is arranged or provided in the case of an abrasive grain stood up on an abrasive article substrate, on a side of the abrasive grain facing away from the abrasive article substrate. Here, the cutting element can be arranged on the abrasive grain in such a way that it is in a position which points away maximally from the abrasive article substrate. In the case of an essentially rectangular or square shape of the abrasive grain, “essentially opposite” can likewise mean that both a parallel to the standing face is realized as cutting element and/or the two corners adjoining this parallel of the rectangular, in particular square, shaped abrasive grain are realized as cutting element(s). The cutting element can break during a grinding process, with the cutting element then being replaced by a freshly formed cutting element, in particular a new edge, corner and/or point; however, such a (secondary) cutting element formed by fracture of the abrasive grain is for the purposes of the present text not considered as a cutting element according to the invention.

The cutting element has at least one facet which is arranged or oriented at an oblique angle to the main faces and serves to realize a sharp edge or corner, in particular a point. Here, the “facet” is a chamfering at the periphery of the abrasive grain, and the facet likewise represents a side face of the abrasive grain. The facet is, in particular, flat or slightly convex or concave. In one embodiment of the abrasive grain, the facet can be described essentially by a plane which approximates the facet and optionally averages out unevennesses present in the facet. In a manner similar to a knife, the facet thus forms a face of the cutting edge of a blade of the knife. Here, “oblique-angled” means, in particular, an angle of not 0° and not 90° (or multiples of 90°). In one embodiment of the abrasive grain, the at least one facet of the at least one cutting element forms an angle, in particular an internal angle (located in the interior of the abrasive grain), of from 115° to 170°, in particular from 130° to 150°, very particularly from 140° to 150°, to an adjoining main face.

In one embodiment of the abrasive grain, the two essentially parallel main faces having a polygonal geometry are congruent to one another, i.e. they can be made coincident by rotation and translation. In an alternative embodiment of the abrasive grain, the two essentially parallel main faces having a polygonal geometry are not congruent to one another. This makes it possible to realize abrasive grains having different properties, in particular in respect of their manufacture and in respect of their abrasive properties.

In one embodiment of the abrasive grain, the abrasive grain is delimited by the facet in such a way that the cutting element forms at least one point. A point represents a particularly sharp cutting element which is therefore particularly advantageous for exercising an abrasive effect.

In an alternative or additional embodiment of the abrasive grain, the abrasive grain is delimited by the facet in such a way that the cutting element forms at least one edge, namely a cutting edge. An edge represents a likewise sharp cutting element which is therefore particularly advantageous for exercising an abrasive effect. In addition, owing to its elongated configuration, an edge represents a cutting element which is stable and sharp over a prolonged period of time. Maintenance of the cutting element which comes into contact with the workpiece during a grinding process results in a longer life combined with the same high abrasive performance of the abrasive grain.

In one embodiment of the abrasive grain, the at least one edge is arranged essentially parallel to the main faces. Here, “essentially parallel” means that a deviation from an ideal parallel arrangement is less than 35°, in particular less than 15°, very particularly less than 5°. It can be ensured in this way that the cutting element of each abrasive grain has a clearly defined and easily determinable orientation, in particular an orientation which can be determined by simple optical means on the basis of the orientation of the abrasive grain. In particular, a technically and economically particularly simple but nevertheless precise orientation of the edge of the cutting element can likewise be realized via an orientation of the optically readily discernible main faces.

In one embodiment of the abrasive grain, the at least one edge is arranged essentially parallel to the standing face. Here, “essentially parallel” likewise means that a deviation from an ideal parallel arrangement is less than 35°, in particular less than 15°, very particularly less than 5°. It can be ensured in this way that the edge of the cutting element can preferably be oriented essentially parallel to the abrasive article, in particular the abrasive article substrate, when the abrasive grain is stood up on the standing face. Furthermore, the cutting elements of a plurality of abrasive grains are, when these are placed on a common abrasive article substrate, arranged parallel to the abrasive article substrate and preferably with an identical cutting height above the surface of the abrasive article substrate.

In one embodiment of the abrasive grain, the at least one edge is arranged essentially at an angle of 45° based on the standing face. Here, “essentially at an angle of 45°” means that a deviation from an ideal 45° arrangement is less than 15°, in particular less than 10°, very particularly less than 5°. It is in this way possible to change the angle of inclination of the edge in respect of the abrasive grain and influence and/or set the abrasive effect.

In one embodiment of the abrasive grain, the at least one edge is formed by the intersection line of one of the main faces and the at least one facet. The intersection line forms an imaginary, geometric construct in order to describe the edge. In other words, the at least one edge is realized at the place at which one of the main faces and the at least one facet adjoin. This gives a technically and economically particularly easily realizable abrasive grain which, owing to its asymmetric shape (based on a mirror plane which is arranged centrally between two main faces), can be taken particularly easily from a casting mold in a shaping process in the production process. Furthermore, it has been found that an abrasive grain having an asymmetric cutting element has a greater sharpness than an abrasive grain having a symmetric cutting element. It should be noted that in the following symmetry or asymmetry of a cutting element is always the symmetry or asymmetry of the cutting element based on a mirror plane which is arranged centrally between two main faces and parallel to these. Rotational symmetry (which can nevertheless be present) is not meant at the present juncture.

In one embodiment of the abrasive grain, the abrasive grain is characterized by a further facet which is oriented at an oblique angle to the main faces.

In one embodiment, the at least one further facet forms an angle, in particular an internal angle, in the range from 110° to 170°, in particular from 125° to 160°, very particularly from 140° to 150°, with an adjoining main face. The abrasive grain is in this case delimited by the further facet in such a way that the cutting element forms at least one edge, with the at least one edge being formed by the intersection line (place of contact) of the at least one facet and the further facet. In an alternative or additional embodiment of the abrasive grain, the abrasive grain is delimited by the further facet in such a way that the cutting element forms at least one point, with the at least one point being formed by the intersection point of the at least one facet and the further facet. As mentioned above, the intersection line or the intersection point is an imaginary, geometric construct in order to describe the edge or the point. In other words, the edge is realized at the place where the two facets adjoin. In an equivalent way, the point is realized at the place at which a point of each of the two facets adjoin.

In one embodiment of the abrasive grain, the at least one edge is arranged in a plane which lies essentially parallel to the main faces and centrally between the main faces. A particularly effectively grinding, symmetrical abrasive grain can be realized in this way. Furthermore, shear forces during a grinding process are compensated for by the symmetric configuration of the cutting element relative to a mirror plane which is arranged centrally between the two main faces and parallel to these.

Three working examples of abrasive grains according to the invention are presented below. In a first working example according to the invention, the main faces have an n-corner geometry, where n=6 or 8 or 10, with the main faces being connected at in each case n/2 non-contacting edges of the main faces by a respective standing face arranged essentially perpendicularly to the main faces for standing the abrasive grain upright on an abrasive article substrate and a respective cutting element being formed adjoining the main faces at each of further n/2 non-contacting edges of the main faces, where each cutting element comprises at least two facets which are oriented at an oblique angle to the main faces and touch at a common edge or point. The abrasive grain of this working example has (based on a mirror plane arranged centrally between the two main faces and parallel to these) a symmetric cutting element having either a point or an edge, with the two main faces being congruent to one another. An envelope of the abrasive grain is, in particular, triangular, quadrilateral, pentagonal, etc., with each side face of the abrasive grain adjoining the envelope forming/representing a standing face. The abrasive grain thus also has three-fold, four-fold, five-fold, etc., rotational symmetry and can therefore in principle be positioned in the three, four, five, etc., ways on a standing face according to the invention. A particularly simply configured abrasive grain has a triangular envelope, where n=6.

In a second working example according to the invention, the main faces have an n-corner geometry, where n=6 or 8 or 10, with the main faces being joined at n/2 in each case non-contacting edges of the main faces by a standing face arranged essentially perpendicularly to the main faces for standing the abrasive grain upright on an abrasive article substrate and a respective cutting element being formed adjoining the main faces at in each case further n/s non-contacting edges of the main faces, where each cutting element comprises a respective facet oriented at an oblique angle to the main faces so as to form at least one edge as intersection line of one of the main faces and the facet. The abrasive grain of this working example has an asymmetric (based on a mirror plane arranged centrally between the two main faces and parallel thereto) cutting element having an edge, where the two main faces are not congruent to one another. The abrasive grain is thus likewise (based on the abovementioned mirror plane) asymmetric and can therefore be produced technically and economically particularly advantageously by means of a shaping process using a casting mold, and also has a particularly long-life cutting element.

In a third working example according to the invention, one of the main faces has an n-corner geometry, where n=6 or 8 or 10, and one of the main faces has an n/2-corner geometry, with the n-cornered main face being joined at n/2 non-contacting edges to a respective standing face arranged essentially perpendicularly to the main faces for standing the abrasive grain upright on an abrasive article substrate and via this to the n/2-cornered main face and a respective cutting element being formed at the n-cornered main face adjoining in each case further n/2 non-contacting edges of the main faces, where each cutting element comprises a respective facet which is oriented at an oblique angle to the main faces and forms a common point with the n/2-cornered main face. The abrasive grain of this working example has an asymmetric (based on a mirror plane arranged centrally between the two main faces and parallel to these) cutting element having a point, with the two main faces not being congruent to one another. The abrasive grain is thus likewise asymmetric (based on the abovementioned mirror plane) and can therefore be produced technically and economically particularly advantageously by means of a shaping process using a casting mold, and also has a particularly sharp cutting element.

In one embodiment of the abrasive grain, there is a spacing of less than 2000 μm, in particular less than 1500 μm, very particularly less than 1200 μm, between the at least one cutting element and the at least one standing face arranged essentially opposite.

The abrasive grain of the invention can have a size in the entire size range which is also customary for conventional abrasive grains. Abrasive grains having relatively large sizes usually lead to a greater removal of material from a surface being worked than smaller abrasive grains. For example, the abrasive grain can have a size in the range from 100 μm to 2000 μm. This size can be determined experimentally by means of a microscope. For the purposes of the present invention, it is the diameter of a circumscribing circle of the microscopic image of the abrasive grain, i.e. the smallest diameter of a circle which encloses the image. As an alternative, the size can also be taken to be an average diameter of the abrasive grain. The average diameter is the diameter which corresponds to the average distance of all points on the surface of the abrasive grain to the center of the diameter, in particular the geometric center of the abrasive grain.

It may be remarked that it is presumed for abrasive grains having a main face in the form of a triangle, in particular an equilateral triangle, that when such abrasive grains are electrostatically scattered about one to two thirds become oriented so that an apex points away from the substrate while further abrasive grains become oriented so that the apex points at the substrate. This results in advantageous abrasive properties of an abrasive article scattered with the abrasive grains. Furthermore, an abrasive grain can also be placed in a targetedly oriented manner on an abrasive article substrate using a template or else manually. Abrasive articles having a proportion of oriented abrasive grains of up to 100% are conceivable. Abrasive grains having three-fold symmetry according to the invention in particular allow the abrasive grain to be placed on a stable standing face, with a cutting element always being oriented so as to point upward, i.e. away from the abrasive article substrate.

In one embodiment, the shaped ceramic abrasive grain based on alpha-Al₂O₃ contains a proportion of ZrO₂ of from 10% by weight to 30% by weight. In one embodiment, the alpha-Al₂O₃ has an average crystallite size of from 0.5 μm to 3 μm, preferably from 0.6 μm to 2 μm, and the ZrO₂ has an average crystallite size of from 0.25 μm to 8 μm, preferably from 0.3 μm to 1.5 μm. In particular, the ZrO₂ is present in a proportion of from 10% by weight to 25% by weight, very particularly from 15% by weight to 22% by weight. Furthermore, ZrO₂ is used as starting material for producing the ceramic abrasive grain of the invention. ZrO₂ is likewise known per se to a person skilled in the art and is commercially available, for example in powder form. It has been found that an increased proportion of ZrO₂ has an advantageous effect on the abrasive performance of abrasive articles which are provided with the abrasive grains of the invention. It is presumed that the increased proportion of ZrO₂ results in a continuous, microcrystalline breakdown of the abrasive grains which continuously exposes new and sharp cutting edges. An increased proportion of ZrO₂ could be associated with an increased number of weak points in the microstructure of the abrasive grains, which have a positive effect on the abrasive properties of the abrasive grains. An abrasive grain having a proportion of alpha-Al₂O₃ and ZrO₂ is also referred to as two-phase abrasive grain. For the present purposes, an average crystallite size is the grain size of the alpha-Al₂O₃ or ZrO₂ crystallite in the shaped ceramic abrasive grain. Here, an average crystallite size means that an average is formed from a particular number of measured values for the crystallite size. The crystallite size can be determined by means of methods known per se, for example SEM or XRD analysis. For example, the images of an SEM analysis can be evaluated by means of the line intercept method. The line intercept method (also referred to as line method) is known per se to a person skilled in the art from microstructural analysis. Here, an average of all measured intercept segment lengths is formed for determining the grain size. Optionally, a correction factor can also be taken into account in determining the average.

The invention further provides an abrasive article which comprises shaped ceramic abrasive grains according to the invention. The abrasive article is, in particular, a coated abrasive article. The abrasive article comprises, in particular, a flexible substrate having at least one layer, in particular of paper, paperboard, vulcanized fiber, foam, a polymer, a textile structure, in particular a woven fabric, formed-loop knitted fabric, drawn-loop knitted fabric, braid, nonwoven or a combination of these materials, in particular paper and woven fabrics, in one or more layers. The flexible substrate gives the abrasive article specific properties in respect of adhesion, elongation, tear and tensile strength, flexibility and stability. In a coated abrasive article, the abrasive grains adhere, in particular by means of a base binder, to the substrate. The abrasive grains are prefixed using the base binder, especially in the desired position and distribution, on the substrate. Suitable base binders for applying abrasive grains to a flexible substrate are adequately known to a person skilled in the art from the prior art. Possible base binders are, in particular, synthetic resins such as phenolic resin, epoxy resin, urea resin, melamine resin, polyester resin. In addition to the base binder, the abrasive article can have at least one covering binder, for example two covering binders. The covering binder or binders are, in particular, applied in layers to the base binder and the abrasive grains. Here, the covering binder or binders firmly joins the abrasive grains to one another and firmly to the substrate. Suitable covering binders are also adequately known to a person skilled in the art from the prior art. Possible covering binders are, in particular, synthetic resins such as phenolic resin, epoxy resin, urea resin, melamine resin, polyester resin. In addition, further binders and/or additives can be provided in order to give the abrasive article specific properties. A person skilled in the art will be familiar with such binders and/or additives. Alternative abrasive articles, for example bonded abrasive articles, are likewise possible. Bonded abrasive articles are, in particular, synthetic resin-bonded parting disks and grinding disks, with which a person skilled in the art will be familiar. To produce synthetic resin-bonded parting and grinding disks, a composition is made up by mixing abrasive minerals and also fillers, pulverulent resin and liquid resin and this composition is then pressed to give parting and grinding disks of various thicknesses and diameters. The abrasive article can be present in different manufactured forms, for example as abrasive disk or as abrasive band, as sheet, roll or strip.

In a variant of the abrasive article, differently shaped and/or unshaped, in particular crushed “further” abrasive grains, and/or partially shaped “further” abrasive grains are present in addition to the inventive shaped ceramic abrasive grains. These further abrasive grains serve, for example, as support grains. In this variant of the abrasive article, the proportion of shaped ceramic abrasive grains according to the invention is at least 5%, in particular at least 15%, preferably at least 25%, particularly preferably at least 50%, based on the total amount of abrasive grains (for example able to be reported as percent by weight). Unshaped ceramic abrasive grains have, in contrast to shaped ceramic abrasive grains, no defined geometry. They do not have a defined three-dimensional shape of defined size. In the production of such abrasive grains, no defined shaping process takes place. Unshaped abrasive grains are of irregular and random shape. They can be produced by comminution, for example by crushing, with comminution being carried out in a random manner so that the abrasive grains are formed by fragments. Such unshaped, in particular crushed, abrasive grains are adequately known to a person skilled in the art. The production thereof is described, for example, in EP 947485 A1. Partially shaped ceramic abrasive grains do not have any completely defined geometry, in contrast to shaped ceramic abrasive grains. Partially shaped abrasive grains partially have, in contrast to unshaped abrasive grains, a defined geometry having a partially defined three-dimensional shape of partially defined size. For example, partially shaped abrasive grains have at least one defined side face, in particular at least two defined side faces, and/or at least one defined edge, in particular at least two defined edges. Partially shaped abrasive grains have at least one randomly shaped side face and/or at least one randomly shaped edge. Such abrasive grains can, for example, be produced by firstly carrying out shaping to give a precursor and subsequently carrying out comminution of the precursor. Thus, for example, a layer having two essentially parallel side faces can firstly be formed. This layer can subsequently be comminuted in a random manner, forming irregularly shaped fracture edges. Such partially shaped abrasive grains are described, for example, in DE 102015108812 A1.

It has been found that an abrasive article comprising a mixture of abrasive grains having properties according to the invention and further abrasive grains likewise gives an improved abrasive performance. Such an abrasive article has, compared to an abrasive article in which only abrasive grains according to the invention are present, the advantage that the abrasive article can be produced more quickly industrially and is thus cheaper.

In one embodiment of the abrasive article, the shaped ceramic abrasive grains are arranged on the abrasive article substrate of the abrasive article in such an orientation that they stand on at least one standing face for standing the abrasive grain upright on the abrasive article substrate. This ensures that the cutting element arranged essentially opposite to the standing face points away from the abrasive article substrate and toward a workpiece to be machined. The targeted setting of abrasive grains on an abrasive article substrate results in a very large number of abrasive grains participating in a grinding process due to a homogeneous height distribution. In particular, it is conceivable that up to 100% of the abrasive grains are oriented in an upright position as a result of targeted setting and, due to their homogeneous height, thus contribute to a particularly strong abrasive effect.

In one embodiment of the abrasive article, the shaped ceramic abrasive grains are arranged in essentially such an orientation on the abrasive article substrate of the abrasive article that the main faces are oriented parallel to a direction of an intended use of the abrasive article. Here, “essentially in such an orientation” means that at least 50%, in particular at least 70%, very particularly at least 90%, of the abrasive grains according to the invention are oriented with their main faces parallel to a direction of an intended use of the abrasive article. In this way, it is possible to realize a particularly good abrasive effect of the abrasive article. The direction of an intended use is typically predetermined by the shape of the abrasive article and in particular by the intended grinding process (for example using an abrasive band in a band grinding appliance with a linear direction of movement of the abrasive band or using an abrasive disk in a rotary grinding appliance with a circular or elliptical direction of movement of the abrasive disk). As a result of the abrasive grains being appropriately oriented, the cutting elements of the abrasive grains are likewise advantageously oriented in the direction of the intended use of the abrasive article. Owing to the abrasive grain geometry according to the invention, it is possible to arrange cutting elements of the abrasive grains, i.e., for example, edge or point of the abrasive grain, parallel to the direction of the intended use of the abrasive article, with at the same time a stabilizing longitudinal edge of the abrasive article likewise being oriented in the direction of the intended use of the abrasive article. In this way, the abrasive grain is advantageously arranged so that it can oppose a particularly high resistance as a result of particularly stable positioning (the abrasive grain cannot tip over) to the high mechanical loading (force) which acts during the grinding process as a result of the movement relative to the workpiece. Consequently, targeted setting of the abrasive grains allows these to be oriented in such a way that the main faces and thus also the cutting element, in particular the edge or point, are oriented parallel to the direction of the intended use of the abrasive article. A particularly sharp cut through the workpiece to be ground with a small cutting area are particular advantages, with friction losses being reduced and evolution of heat in a grinding process being decreased at the same time. Overall, the properties of the abrasive article realized in this way are significantly improved.

The invention further provides a casting mold for producing the abrasive grains of the invention in a process according to the invention for producing the abrasive grains. The casting mold for producing shaped ceramic abrasive grains according to the invention has at least one mold cavity, in particular a plurality of mold cavities, wherein the at least one mold cavity comprises a lower mold surface, a mold side wall and a depth between lower mold surface and surface of the casting mold. In a working example, the depth is about 450 μm. The mold cavity has a shape complementary to the shape of at least part of the surface of the abrasive grain according to the invention, with the cross-sectional geometry of the at least one mold cavity corresponding to the cross-sectional geometry of the abrasive grain. To form the at least one cutting element, the mold cavity can have corresponding features such as, for example, bevels or the like. The casting mold can comprise, for example, silicone or other, in particular thermoplastic, polymers such as thermoplastic polyurethane (TPU), polyvinyl chloride (PVC) or the like or consist thereof. The depressions can have an open covering area through which a dispersion can be introduced.

The invention additionally provides a process for producing a shaped ceramic abrasive grain, where the abrasive grain has a geometry according to the invention. The process comprises the following steps:
a) production of a slip comprising at least an alpha-Al₂O₃ powder, in particular with additions of a ZrO₂ powder, and a dispersant, where a solids content in the slip is from 50% by weight to 90% by weight and an average particle size is from 0.1 μm to 8 μm;
b) introduction of the slip into depressions of a casting mold, where the depressions have a defined geometry according to the invention;
c) drying of the slip in the depressions to give abrasive grain precursors, where a solids content of the abrasive grain precursors is from 85% by weight to 99.9% by weight;
d) removal of the abrasive grain precursors from the depressions;
e) sintering of the abrasive grain precursors to give abrasive grains.

The process of the invention is based on the slip process in this embodiment. The production of the shaped ceramic abrasive grains according to the invention is here in particular not carried out by the sol-gel process which is adequately known from the literature. The individual process steps are, in particular, described in more detail in DE 10 2017 207 322 A1.

### DRAWINGS

The invention will now be illustrated in the following description with the aid of working examples depicted in the drawings. The drawings, the description and the claims contain numerous features in combination. A person skilled in the art will advantageously also look at the features individually and combine them to give useful further combinations. Identical reference numerals in the figures designate identical elements.

The figures show:

FIG. 1 a schematic view of one embodiment of a ceramic shaped abrasive grain according to the prior art;

FIG. 2 a schematic view of a first embodiment of a ceramic shaped abrasive grain according to the invention having at least one cutting element, where the cutting element comprises at least one facet oriented at an oblique angle to the main faces;

FIG. 3 a schematic view of a second embodiment of a ceramic shaped abrasive grain according to the invention;

FIG. 4 a schematic view of a third embodiment of a ceramic shaped abrasive grain according to the invention;

FIG. 5 a schematic view of a fourth embodiment of a ceramic shaped abrasive grain according to the invention;

FIG. 6 a schematic view of a fifth embodiment of a ceramic shaped abrasive grain according to the invention;

FIG. 7 a schematic view of a sixth embodiment of a ceramic shaped abrasive grain according to the invention;

FIG. 8 a schematic view of a seventh embodiment of a ceramic shaped abrasive grain according to the invention;

FIG. 9 a schematic view of an eighth embodiment of a ceramic shaped abrasive grain according to the invention;

FIG. 10 a schematic view of a ninth embodiment of a ceramic shaped abrasive grain according to the invention;

FIG. 11 a section of a schematic sectional view of an embodiment of the abrasive article according to the invention;

FIG. 12 a section of a schematic sectional view of an alternative embodiment of the abrasive article according to the invention with directionally positioned abrasive grains;

FIG. 13 a flow diagram to illustrate the process steps for producing a shaped ceramic abrasive grain according to the invention.

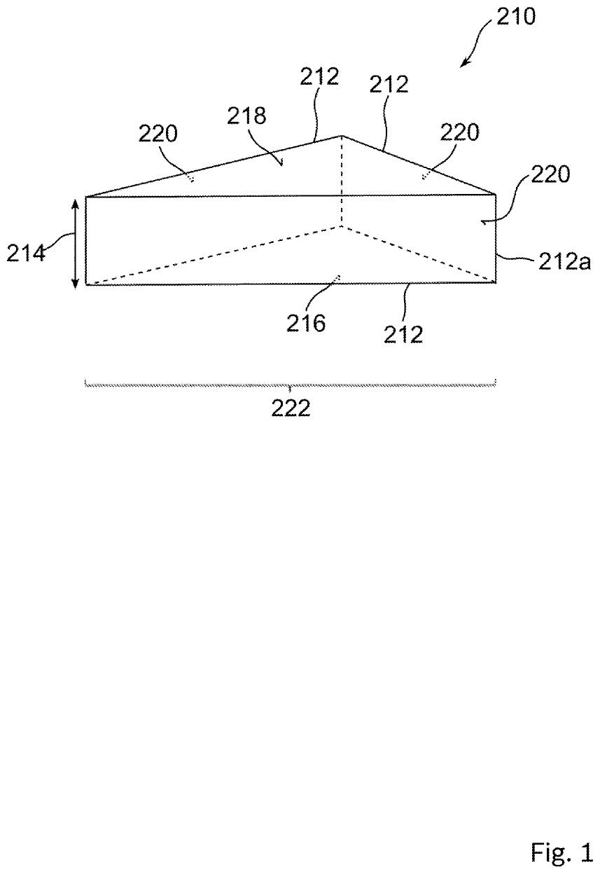

FIG. 1 schematically shows (in particular not true to scale) an illustrative embodiment of a shaped ceramic abrasive grain 210 as is known from the prior art. The geometric shape of the abrasive grain 210 is formed by a regular three-sided upright prism having the side edges 212 and the height edges 212a with the height 214. The main face 216 and the covering face 218 are accordingly each formed by three side edges 212 of equal length. The main face 216 and the covering face 218 have the same size and are spaced from one another by the height 214. The three side faces 220 are formed by rectangles and are of essentially the same size. In the illustrative embodiment of FIG. 1, the side edges 212 have a length 222 of 1400 μm. The height 214 is 410 μm. The ceramic abrasive grain 210 is produced based on alpha-Al₂O₃.

In the following, embodiments of the shaped ceramic abrasive grain 10, 10a-i according to the invention for an abrasive article 50 are presented. The proposed shaped ceramic abrasive grain 10, 10a-i is likewise produced based on alpha-Al₂O₃ in these examples and has two essentially parallel main faces 12a, 12b which have a polygonal geometry and are joined by at least one standing face 14 arranged essentially perpendicularly to the main faces 12a, 12b for standing the abrasive grain 10, 10a-i upright on an abrasive article substrate 52. The abrasive grain 10, 10a-i has at least one cutting element 16, 16a-i which is arranged essentially opposite the at least one standing face 14, where the cutting element 16, 16a-i comprises at least one facet 18 oriented at an oblique angle to the main faces 12a, 12b. The size of the abrasive grains 10, 10a-i depicted is in the range from 100 μm to 2000 μm (for example determined as diameter of a circle which can be fitted into the abrasive grain 10, 10a-i), depending on the desired fineness of a grinding result to be achieved.

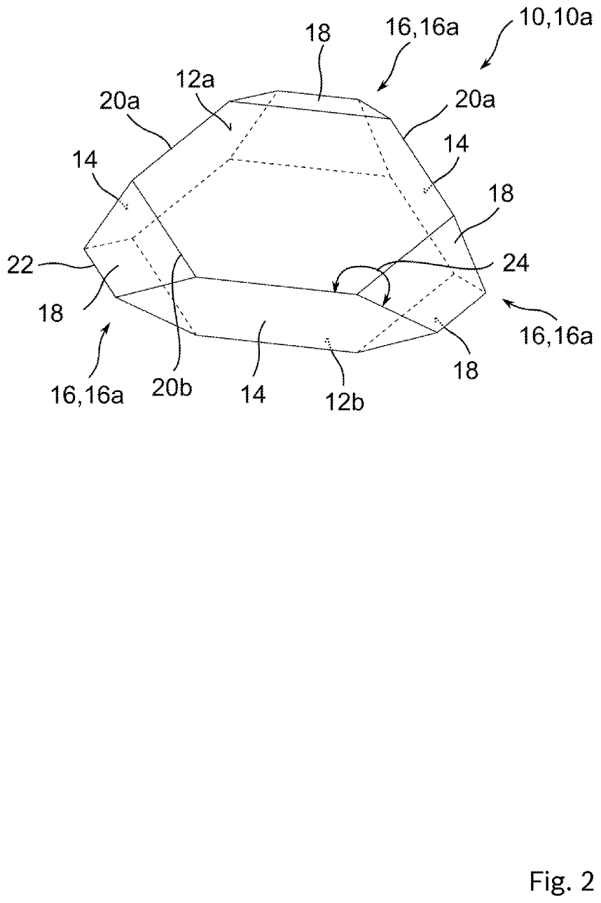

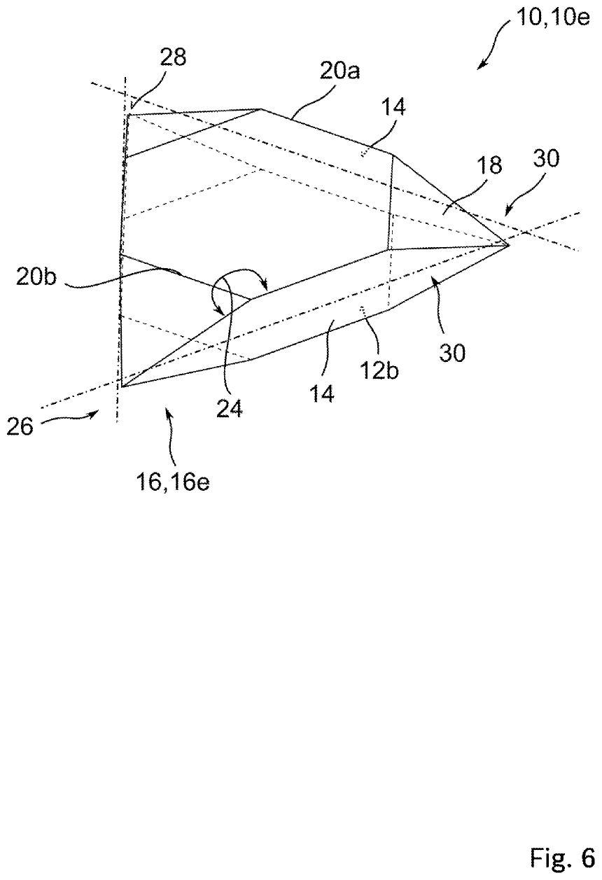

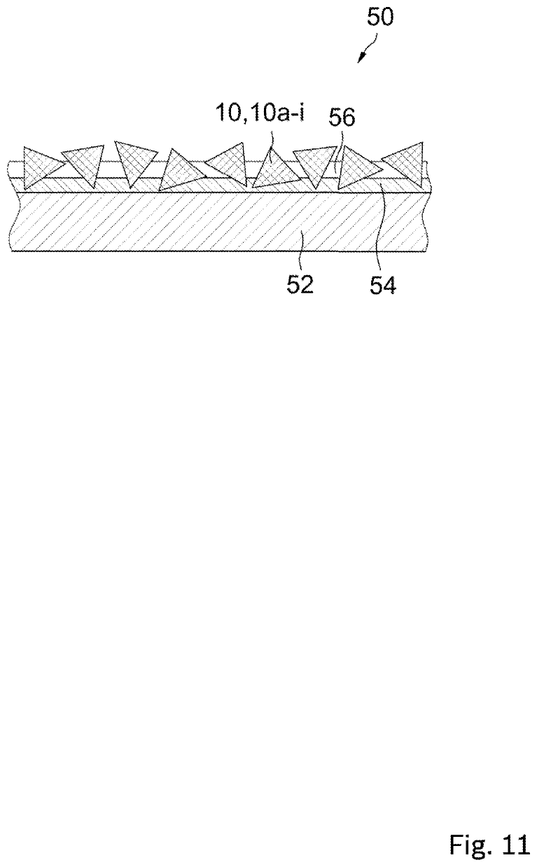

FIG. 2 depicts an illustrative embodiment of the ceramic shaped abrasive grain 10, 10a of the invention. The abrasive grain 10, 10a has a first main face 12a and a second main face 12b which each have a hexagonal geometry. The main faces 12a, 12b are congruent and are joined at each of three non-contacting edges 20a of the main faces 12a, 12b by one in each case (i.e. three in total) standing face 14 which is arranged essentially perpendicularly to the main faces 12a, 12b for standing the abrasive grain 10, 10a upright on an abrasive article substrate 52 (cf. FIG. 11). Adjoining the main faces 12a, 12b, a respective cutting element 16, 16a is formed on in each case a further three non-contacting edges 20b of the main faces 12a, 12b, where each cutting element 16, 16a comprises two facets 18 which are oriented at an oblique angle to the main faces 12a, 12b and contact one another in a common edge 22. The facets 18 each form an external angle 24 of about 206° (internal angle about) 154° to an adjoining main face 12a, 12b. The respective edge 22 is arranged essentially parallel to the main faces 12a, 12b and essentially parallel to the standing face 14 arranged opposite. In particular, the edge 22 is arranged in a plane (not shown in more detail here, but cf. FIG. 6, there reference numeral 28) which lies essentially parallel to the main faces 12a, 12b centrally between the main faces 12a, 12b. Thus, the abrasive grain 10, 10a in this working example has three symmetric (in respect of a mirror plane arranged centrally between the two main faces 12a, 12b and parallel to these) cutting elements 16, 16a, each having an edge 22. An envelope of the abrasive grain 10, 10a (not shown in more detail here, but cf. FIG. 6) is triangular, with each side face of the abrasive grain 10, 10a adjoining the envelope representing a standing face 14. The edge length of the envelope is 2.1 mm, and the thickness of the abrasive grain 10, 10a (i.e. the spacing of the main faces 12a, 12b) is 340 μm. The abrasive grain 10, 10a has three-fold rotational symmetry.

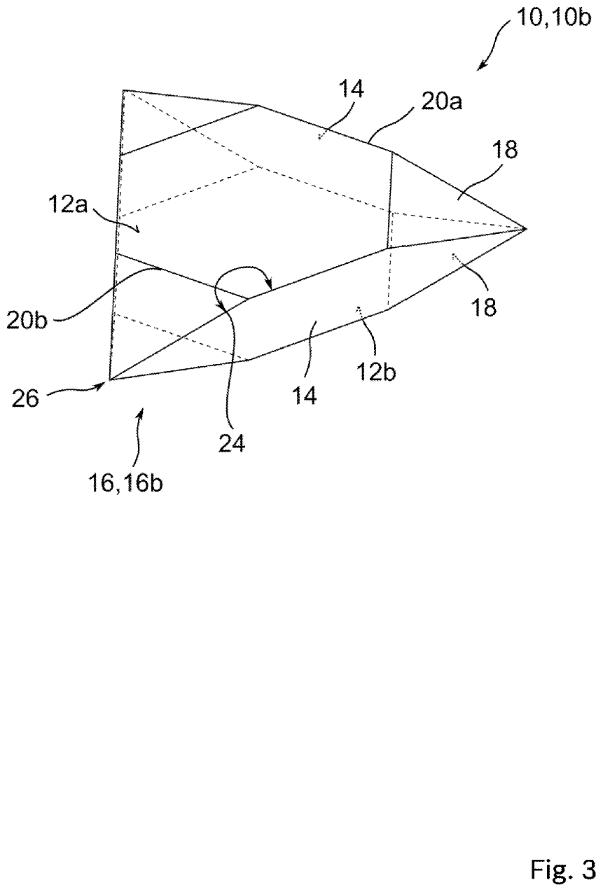

Similarly to the abrasive grain 10, 10a of FIG. 2, the abrasive grain 10, 10b in FIG. 3 has a first main face 12a and a second main face 12b which each have a hexagonal geometry. The main faces 12a, 12b are congruent and are joined at in each case three non-contacting edges 20a of the main faces 12a, 12b by a respective standing face 14 arranged essentially perpendicularly to the main faces 12a, 12b for standing the abrasive grain 10, 10b upright on an abrasive article substrate 52. Adjoining the main faces 12a, 12b, there is formed a respective cutting element 16, 16b at each of a further three non-contacting edges 20b of the main faces 12a, 12b, where each cutting element 16, 16b comprises two facets 18 which are arranged at an oblique angle to the main faces 12a, 12b and contact one another in a common point 26.

The facets 18 each form an external angle 24 of about 194° (internal angle about 166°) to an adjoining main face 12a, 12b. The respective point 26 is arranged in a plane (not shown here, but cf. FIG. 6) which lies essentially parallel to the main faces 12a, 12b centrally between the main faces 12a, 12b. The abrasive grain 10, 10b thus has three symmetric (in respect of a mirror plane arranged centrally between the two main faces 12a, 12b and parallel to these) cutting elements 16, 16b, each having a point 26. An envelope of the abrasive grain 10, 10b (not shown in more detail here, but cf. FIG. 6) is likewise triangular, with each side face of the abrasive grain 10, 10b adjoining the envelope representing a standing face 14. The edge length of the envelope is 2.1 mm, and the thickness of the abrasive grain 10, 10b is 340 μm. The abrasive grain 10, 10b has three-fold rotational symmetry.

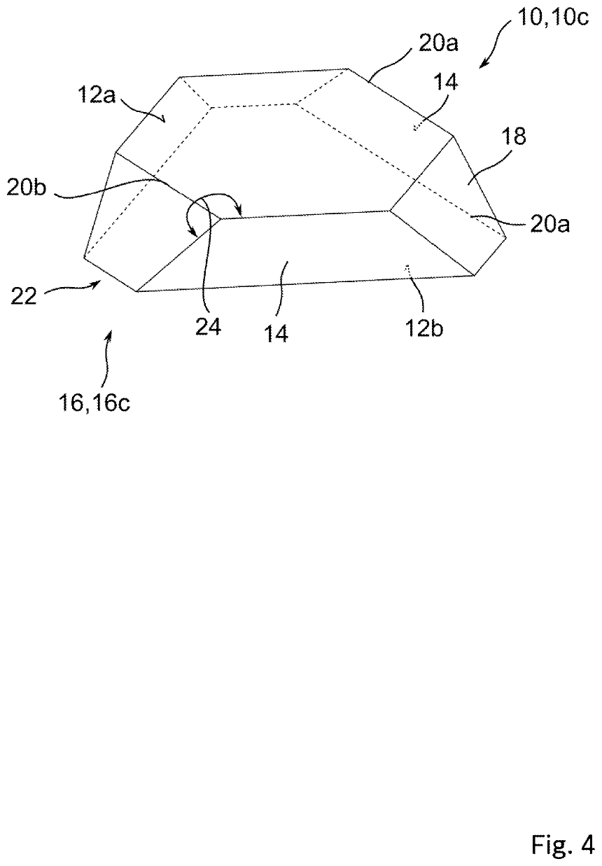

The abrasive grain 10, 10c of the depiction in FIG. 4 has two main faces 12a, 12b which do not have a congruent geometry, although both main faces 12a, 12b in each case have a hexagonal shape. The main faces 12a, 12b are joined at each of three non-contacting edges 20a of the main faces 12a, 12b by a respective standing face 14 arranged essentially perpendicularly to the main faces 12a, 12b for standing the abrasive grain 10, 10c upright on an abrasive article substrate 52. Adjoining the main faces 12a, 12b there is formed a respective cutting element 16, 16c at each of a further three non-contacting edges 20b of the main faces 12a, 12b, where each cutting element 16, 16c comprises a facet 18 which is oriented at an oblique angle to the main faces and forms at least one edge 22 as intersection line of the main face 12b and the facet 18 (it may be pointed out that the edge 20b corresponds to the edge 22 based on the main face 12b).

The facets 18 each form an external angle 24 of about 224° (internal angle about 136°) to the adjoining main face 12a. The respective edge 22 is arranged essentially parallel to the main faces 12a, 12b and essentially parallel to a standing face 14 arranged correspondingly opposite. However, in this case the edge 22 is not arranged in a plane (not shown in more detail here, but cf. FIG. 6) which lies essentially parallel to the main faces 12a, 12b centrally between the main faces 12a, 12b. The abrasive grain 10, 10c thus has three asymmetric, in respect of this plane, cutting elements 16, 16c each having an edge 22. An envelope of the abrasive grain 10, 10c (not shown in more detail here, but cf. FIG. 6) is once again triangular, with each side face of the abrasive grain 10, 10c adjoining the envelope representing a standing face 14. The edge length of the envelope is 2.1 mm, and the thickness of the abrasive grain 10, 10c is 340 μm. The abrasive grain 10, 10c has three-fold rotational symmetry.

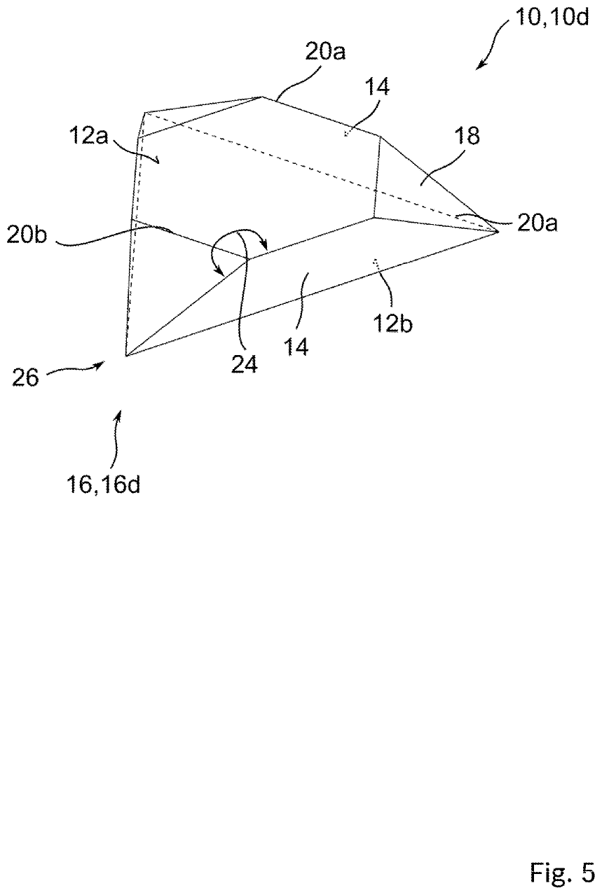

In the working example of the abrasive grain 10, 10d depicted in FIG. 5, one main face 12a has a hexagonal geometry while the second main face 12b has a triangular geometry. The hexagonal main face 12a is joined at three non-contacting edges 20a to in each case a standing face 14 arranged essentially perpendicularly to the main faces 12a, 12b for standing the abrasive grain 10, 10d upright on an abrasive article substrate 52 and the triangular main face 12b. Here, a respective cutting element 16, 16d is formed adjoining the hexagonal main face 12a at in each case a further three non-contacting edges 20b of the main face 12a, where each cutting element 16, 16d has a respective facet 18 which is oriented at an oblique angle to the main faces 12a, 12b and forms a common point 26 with the triangular main face 12b. The facets 18 each form an external angle 24 of about 206° (internal angle about 154°) to the adjoining main face 12a. The respective point 26 is therefore in this case likewise not arranged in a plane (not shown in more detail here, but cf. FIG. 6) which lies essentially parallel to the main faces 12a, 12b centrally between the main faces 12a, 12b. The abrasive grain 10, 10d has an asymmetric cutting element 16, 16d with a point 26, where the two main faces 12a, 12b are not congruent to one another. The abrasive grain 10, 10d is thus likewise arranged asymmetrically in respect of a mirror plane arranged centrally between the two main faces 12a, 12b and parallel to these. The abrasive grain 10, 10d thus has three cutting elements 16, 16d each having a point 26. An envelope of the abrasive grain 10, 10d (not shown in more detail here, but cf. FIG. 6) is likewise triangular, with each side face of the abrasive grain 10, 10d adjoining the envelope representing a standing face 14. The edge length of the envelope is 2.1 mm, and the thickness of the abrasive grain 10, 10d is 340 μm. The abrasive grain 10, 10d has three-fold rotational symmetry.

Similarly to the abrasive grain 10, 10b of FIG. 3, the working example of the abrasive grain 10, 10e of FIG. 6 has a first main face 12a and a second main face 12b which each have a hexagonal geometry. The main faces 12a, 12b are congruent and are joined at in each case three non-contacting edges 20a of the main faces 12a, 12b by a respective standing face 14 arranged essentially perpendicularly to the main faces 12a, 12b for standing the abrasive grain 10, 10e upright on an abrasive article substrate 52. A cutting element 16, 16e is respectively formed adjoining the main faces 12a, 12b at in each case a further three non-contacting edges 20b of the main faces 12a, 12b, where each cutting element 16, 16e comprises two facets 18 which are oriented at an oblique angle to the main faces 12a, 12b and contact one another at a respective common point 26. The respective point 26 is, however, not arranged in a plane 28 which lies essentially parallel to the main faces 12a, 12b centrally between the main faces 12a, 12b. The abrasive grain 10, 10e thus has three asymmetric (in respect of this plane) cutting elements 16, 16e each having a point 26. An envelope 30 of the abrasive grain 10, 10e is likewise triangular, with each side face of the abrasive grain 10, 10e adjoining the envelope representing a standing face 14. The edge length of the envelope is 2.1 mm, and the thickness of the abrasive grain 10, 10e is 340 μm. The abrasive grain 10, 10e has three-fold rotational symmetry.

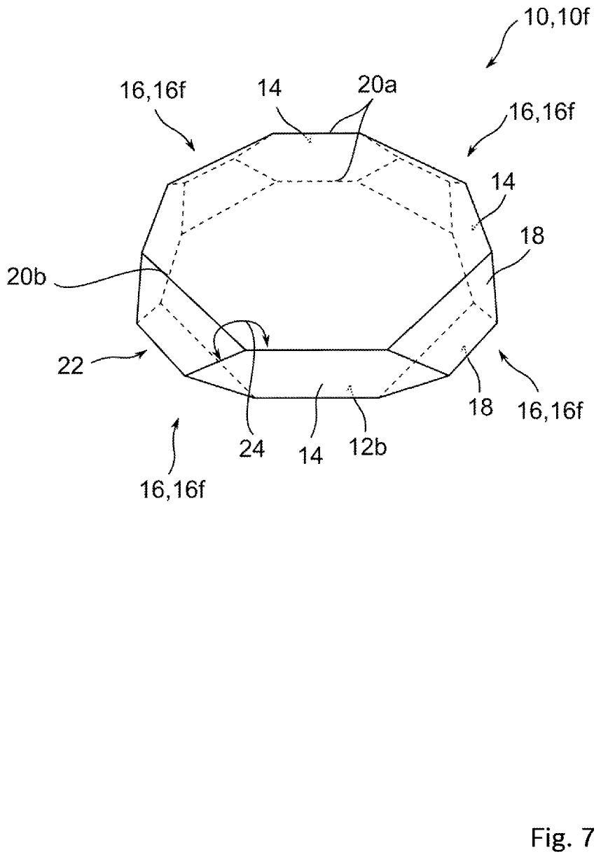

The working examples of FIGS. 7 to 10 concern abrasive grains 10, 10f-i whose envelope (not shown in more detail here, but cf. in principle FIG. 6) has a rectangular shape, in particular square shape. FIG. 7 depicts an illustrative embodiment of the ceramic shaped abrasive grain 10, 10f according to the invention in which the abrasive grain 10, 10f has a first main face 12a and a second main face 12b which each have an octagonal geometry. The main faces 12a, 12b are congruent and joined at in each case four non-contacting edges 20a of the main faces 12a, 12b by a respective standing face 14 arranged essentially perpendicularly to the main faces 12a, 12b for standing the abrasive grain 10, 10f upright on an abrasive article substrate 52. Adjoining the main faces 12a, 12b, a respective cutting element 16, 16f is formed at in each case a further four non-contacting edges 20b of the main faces 12a, 12b, where each cutting element 16, 16f comprises two facets 18 which are oriented at an oblique angle to the main faces 12a, 12b and contact one another in a common edge 22. The facets 18 each form an external angle 24 of about 223° (internal angle about 137°) to an adjoining main face 12a, 12b. The respective edge 22 is oriented essentially parallel to the main faces 12a, 12b and at an angle of essentially 45° to the standing face 14 arranged opposite. In particular, the edge 22 is arranged in a plane (not shown in more detail here, but cf. FIG. 6) which lies essentially parallel to the main faces 12a, 12b centrally between the main faces 12a, 12b. The abrasive grain 10, 10f thus has four cutting elements 16, 16f which are symmetric in respect of this plane and each have an edge 22. An envelope of the abrasive grain 10, 10f (not shown in more detail here, but cf. FIG. 6) is square, with each side face of the abrasive grain 10, 10f adjoining the envelope representing a standing face 14. The edge length of the envelope is 1.8 mm, and the thickness of the abrasive grain 10, 10f (i.e. the spacing of the main faces 12a, 12b) is 400 μm. The abrasive grain 10, 10f has four-fold rotational symmetry.

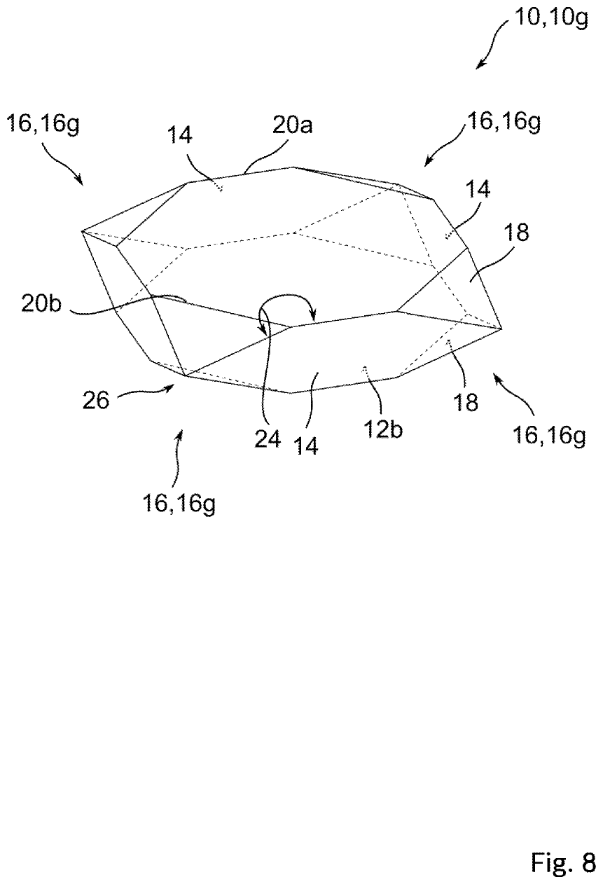

FIG. 8 depicts an embodiment of the abrasive grain 10, 10g in which each cutting element 16, 16g comprises at least two facets 18 which are oriented at an oblique angle to the main faces 12a, 12b and contact one another in a common point 26. The facets 18 each form an external angle 24 of about 205° (internal angle about 155°) to an adjoining main face 12a, 12b. The point is arranged in a plane (not shown in more detail here, but cf. FIG. 6) which lies essentially parallel to the main faces 12a, 12b centrally between the main faces 12a, 12b. The abrasive grain 10, 10g thus has four cutting elements 16, 16f which are symmetric in respect of this plane and each have a point 26. Here too, the envelope of the abrasive grain 10, 10g (not shown in more detail here, but cf. FIG. 6) is square, with each side face of the abrasive grain 10, 10g adjoining the envelope forming a standing face 14. The edge length of the envelope is 1.8 mm, and the thickness of the abrasive grain 10, 10g is 400 μm.

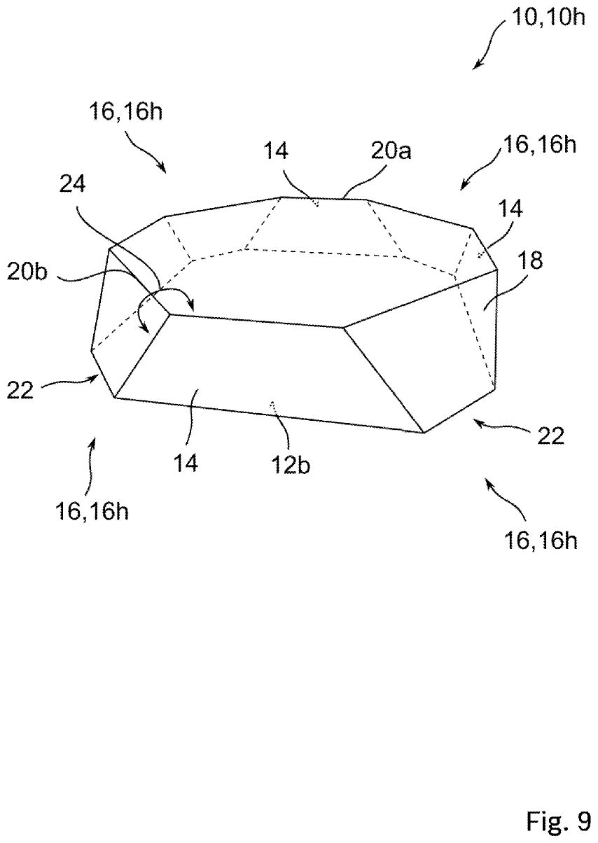

The abrasive grain 10, 10h of the depiction in FIG. 9 has two main faces 12a, 12b which do not have a congruent geometric shape, but each of the two main faces 12a, 12b has an octagonal shape. The main faces 12a, 12b are joined at in each case four non-contacting edges 20a of the main faces 12a, 12b by a respective standing face 14 arranged essentially perpendicularly to the main faces 12a, 12b for standing the abrasive grain 10, 10h upright on an abrasive article substrate 52. Adjoining the main faces 12a, 12b, a respective cutting element 16, 16h is formed at in each case a further four non-contacting edges 20b of the main faces 12a, 12b, where each cutting element 16, 16h comprises a facet 18 which is oriented at an oblique angle to the main faces 12a, 12b and forms at least one edge 22 as intersection line of the main faces 12b and the facet 18 (it may be pointed out that the edge 20b corresponds to the edge 22 in respect of the main face 12b). The facets 18 each form an external angle of about 242° (internal angle about 118°) to an adjoining main face 12a. The respective edge 22 is oriented essentially parallel to the main faces 12a, 12b and at an angle of essentially 45° to the standing face 14 arranged opposite. However, the edge 22 is in this case not arranged in a plane (not shown in more detail here, but cf. FIG. 6) which lies essentially parallel to the main faces 12a, 12b centrally between the main faces 12a, 12b. The abrasive grain 10, 10h thus has four cutting elements 16, 16h which are asymmetric in respect of this plane and each have an edge 22. An envelope of the abrasive grain 10, 10h (not shown in more detail here, but cf. FIG. 6) has a quadrilateral geometry, with each side face of the abrasive grain 10, 10h adjoining the envelope representing a standing face 14. The edge length of the envelope is 2.1 mm, and the thickness of the abrasive grain 10, 10h is 340 μm. The abrasive grain 10, 10h has four-fold rotational symmetry.

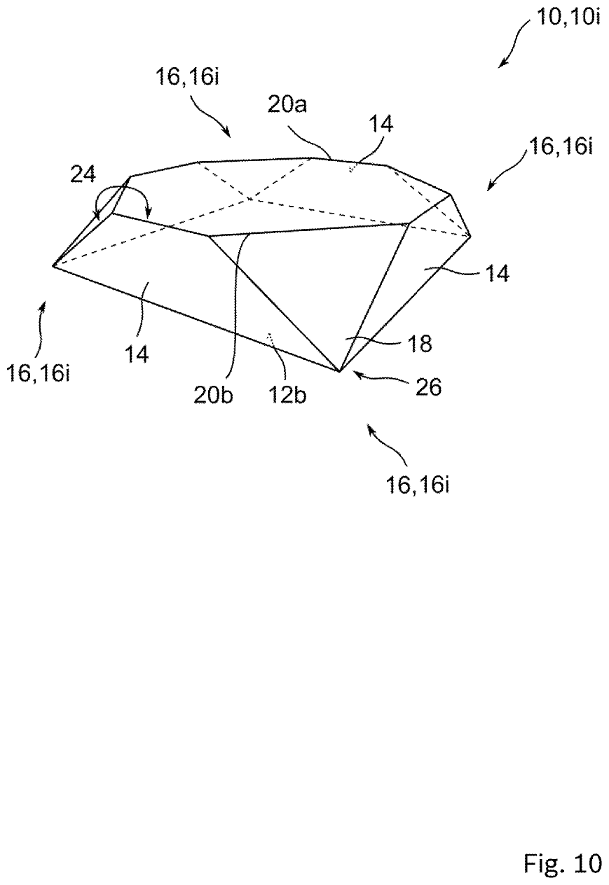

In the case of the working example of the abrasive grain 10, 10i, depicted in FIG. 10, one main face 12a has an octagonal geometry while the second main face 12b has a quadrilateral geometry. The octagonal main face 12a is joined at four non-contacting edges 20a to a respective standing face 14 arranged essentially perpendicularly to the main faces 12a, 12b for standing the abrasive grain 10, 10i upright on an abrasive article substrate 52 and to the quadrilateral main face 12b. Here, a cutting element 16, 16i is respectively formed adjoining the octagonal main face 12a at in each case a further four non-contacting edges 20b of the main faces 12a, where each cutting element 16, 16i comprises a respective facet 18 which is oriented at an oblique angle to the main faces 12a, 12b and forms a common point 26 with the quadrilateral main face 12b. The facets 18 each form an external angle 24 of about 223° (internal angle about) 137° to the adjoining main face 12a. The respective point 26 is therefore likewise not arranged in a plane (not shown in more detail here, but cf. FIG. 6) which lies essentially parallel to the main faces 12a, 12b centrally between the main faces 12a, 12b. The abrasive grain 10, 10i therefore has four cutting elements 16, 16i which are asymmetric in respect of this plane and each have a point 26, with the two main faces 12a, 12b not being congruent to one another. The abrasive grain 10, 10i is thus likewise asymmetric. An envelope of the abrasive grain 10, 10i (not shown in more detail here, but cf. FIG. 6) is likewise quadrilateral, in particular square, with each side face of the abrasive grain 10, 10i adjoining the envelope forming a standing face 14. The edge length of the envelope is 2.1 mm, and the thickness of the abrasive grain 10, 10i is 340 μm. The abrasive grain 10, 10i has four-fold rotational symmetry.

FIG. 11 shows a section of an illustrative embodiment of an abrasive article 50 according to the invention with abrasive grains 10, 10a-i in a schematic sectional view. In the embodiment depicted, the abrasive article 50 is a coated abrasive article 50 having an abrasive article substrate 52 made of vulcanized fiber. The abrasive article substrate 52 composed of vulcanized fiber serves as flexible substrate for the abrasive grains 10, 10a-i. Vulcanized fiber is a composite material comprising cellulose, in particular cotton fibers or cellulose fibers, and is adequately known to a person skilled in the art as flexible substrate for abrasive articles from the prior art. The abrasive grains 10, 10a-i are fixed by means of a base binder 54, for example composed of phenolic resin, to the abrasive article substrate 52. The layer of base binder 54 and abrasive grains 10, 10a-i is coated with a covering binder 56, for example composed of phenolic resin. It may be pointed out that the abrasive grains 10, 10a-i are not positioned with a preferential orientation in this working example.

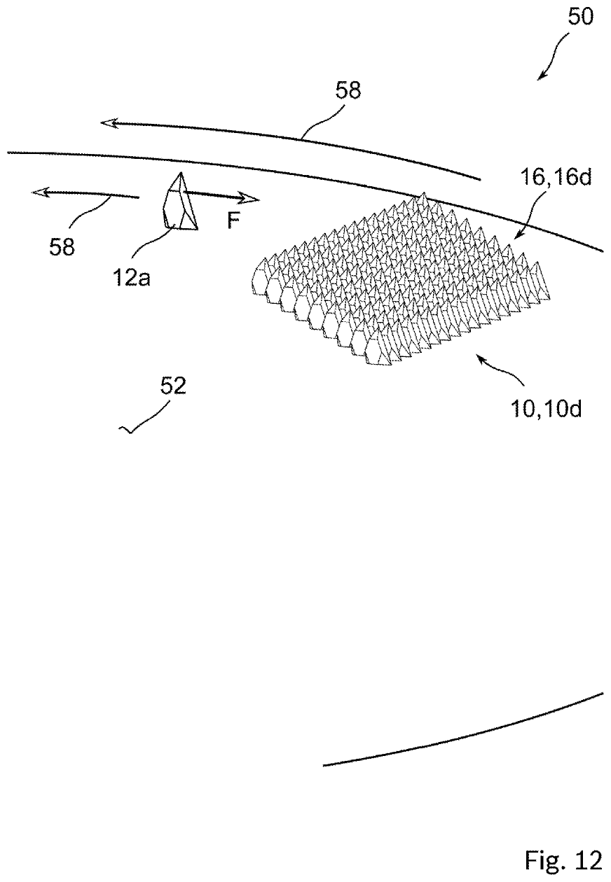

FIG. 12 depicts an abrasive article 50 according to the invention having an advantageous arrangement of the abrasive grains 10, 10d (cf. for abrasive grain 10d FIG. 5 and associated passage in the text; equivalent embodiments also apply to abrasive grains 10, 10a-i) on an abrasive article substrate 52. In this variant of the abrasive article 50, the proportion of shaped ceramic abrasive grains according to the invention is about 100% based on the total amount of abrasive grains. The shaped ceramic abrasive grains 10, 10d are arranged oriented on the abrasive article substrate 52 of the abrasive article 50 in such a way that they stand on at least one standing face 14 for standing the abrasive grain 10, 10d upright on the abrasive grain substrate 52. Here, a cutting element 16, 16d arranged essentially opposite the standing face 14 faces away from the abrasive article substrate 52, toward a workpiece to be machined. Furthermore, the abrasive grains 10, 10d are arranged on the abrasive article 50 in such a way that the main faces 12a, 12b are oriented parallel to a direction 58 of an intended use of the abrasive article 50. It can be seen from the abrasive grain 10, 10d shown by way of example in an enlarged depiction that the standing face is advantageously oriented so that the longitudinal direction of the standing face is aligned in the direction 58 of the intended use of the abrasive article 50. The abrasive grain 10, 10d can thus optimally counter the force “F” which acts. The abrasive grains 10, 10d have a particularly stable seat.

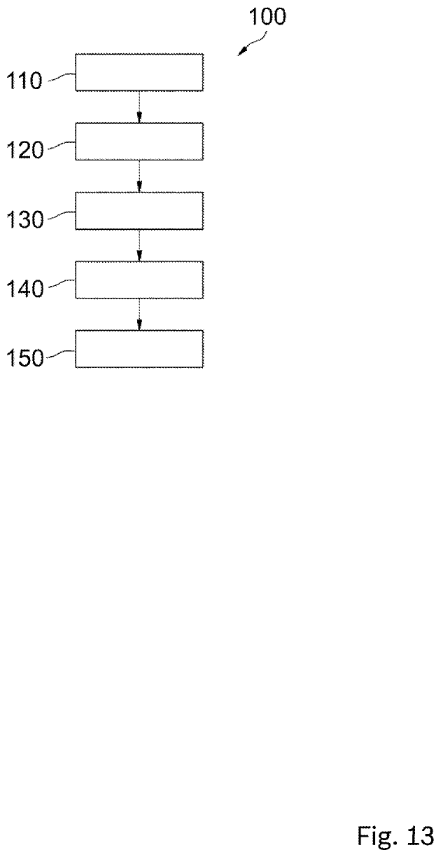

The process of the invention for producing shaped ceramic abrasive grains is illustrated with the aid of the flow diagram of FIG. 13. The production process 100 comprises the following steps. In a first step 110, a slip comprising at least an alpha-Al₂O₃ powder and a dispersant is produced, with a solids content in the slip being from 50% by weight to 90% by weight and an average particle size being from 0.1 μm to 8 μm. In one embodiment of the process, it is additionally possible to use a ZrO₂ powder. In a second step 120, the slip is introduced into depressions in a casting mold (not shown in more detail), where the depressions have a defined geometry. The casting mold has, in particular, a plurality of mold cavities, where the plurality of mold cavities comprises a lower mold surface, a mold side wall and a depth between the lower mold surface and the surface of the casting mold. The plurality of cavities has a form which is complementary to the shape of the abrasive grain 10, 10a-i. In a third step 130, drying of the slip in the depressions is then carried out to give abrasive grain precursors, with a solids content of the abrasive grain precursors being from 85% by weight to 99.9% by weight. After drying of the slip, the abrasive grain precursors are removed from the depressions in a fourth step 140. Furthermore, sintering of the abrasive grain precursors is carried out in a fifth step 150 to give abrasive grains which are based on alpha-Al₂O₃ and have a content of ZrO₂ of from 5% by weight to 30% by weight and a density of from 92% to 99.9% of theoretical density, where the alpha-Al₂O₃ has an average crystallite size of from 0.5 μm to 3 μm and the ZrO₂ has an average crystallite size of from 0.25 μm to 8 μm.

1. A shaped ceramic abrasive grain comprising:
two essentially parallel main faces which have a polygonal geometry;
at least one standing face joining the two main faces and arranged essentially perpendicularly to the main faces, the at least one standing face configured for standing the abrasive grain upright on an abrasive article substrate; and
at least one cutting element arranged essentially opposite the at least one standing face, the at least one cutting element including at least one facet oriented at an oblique angle to the two main faces.

2. The shaped ceramic abrasive grain as claimed in claim 1, wherein the at least one facet forms essentially an angle of from 115° to 170° to an adjoining one of the two main faces.

3. The shaped ceramic abrasive grain as claimed in claim 1, wherein the abrasive grain is delimited by the at least one facet in such a way that the at least one cutting element forms at least one point and/or at least one edge.

4. The shaped ceramic abrasive grain as claimed in claim 3, wherein:
the at least one edge is formed by an intersection line of one of the two main faces and the at least one facet; and/or
the at least one point is formed by an intersection point of one of the two main faces and the at least one facet.

5. The shaped ceramic abrasive grain as claimed in claim 1, further comprising:
a further facet oriented at an oblique angle to the two main faces,
wherein the abrasive grain is delimited by the further facet in such a way that the at least one cutting element forms at least one edge and/or a point, and
wherein (i) the at least one edge is formed by an intersection line of the at least one facet and the further facet and/or (ii) the at least one point is formed by an intersection point of the at least one facet and the further facet.

6. The shaped ceramic abrasive grain as claimed in claim 5, wherein the at least one further facet essentially forms an angle of from 110° to 170° to an adjoining one of the two main faces.

7. The shaped ceramic abrasive grain as claimed in claim 3, wherein the at least one edge is arranged essentially parallel to the two main faces.

8. The shaped ceramic abrasive grain as claimed in claim 3, wherein the at least one edge is arranged essentially parallel to the at least one standing face.

9. The shaped ceramic abrasive grain as claimed in claim 3, wherein the at least one edge is arranged essentially at an angle of 45° relative to the at least one standing face.

10. The shaped ceramic abrasive grain as claimed in claim 5, wherein the at least one edge is arranged in a plane which lies essentially parallel to the two main faces centrally between the two main faces.

11. The shaped ceramic abrasive grain as claimed in claim 1, wherein the two essentially parallel main faces having a polygonal geometry are congruent.

12. The shaped ceramic abrasive grain as claimed in claim 1, wherein the two essentially parallel main faces having a polygonal geometry are not congruent.

13. The shaped ceramic abrasive grain as claimed in claim 1, wherein there is a spacing of less than 2000 μm between the at least one cutting element and the at least one standing face.

14. An abrasive article comprising:
a plurality of shaped ceramic abrasive grains, each of which comprises:
two essentially parallel main faces which have a polygonal geometry;
at least one standing face joining the two main faces and arranged essentially perpendicularly to the main faces, the at least one standing face configured for standing the abrasive grain upright on an abrasive article substrate; and
at least one cutting element arranged essentially opposite the at least one standing face, the at least one cutting element including at least one facet oriented at an oblique angle to the two main faces.

15. The abrasive article as claimed in claim 14, further comprising:
an abrasive article substrate on which the plurality of shaped ceramic abrasive grains are arranged in such a way that each of the plurality of shaped ceramic abrasive grains stands on the at least one standing face.

16. The abrasive article as claimed in claim 14, further comprising:
an abrasive article substrate on which the shaped ceramic abrasive grains are arranged in such a way that the two main faces of each of the plurality of abrasive grains are oriented parallel to a direction of use of the abrasive article.

17. A casting mold for producing shaped ceramic abrasive grains as claimed in claim 1, comprising a plurality of mold cavities that have a form complementary to the shape of the abrasive grain.

18. A process for producing shaped ceramic abrasive grains comprising:
producing shaped ceramic abrasive grains having two essentially parallel main faces which have a polygonal geometry; at least one standing face joining the two main faces and arranged essentially perpendicularly to the main faces, the at least one standing face configured for standing the abrasive grain upright on an abrasive article substrate; and at least one cutting element arranged essentially opposite the at least one standing face, the at least one cutting element including at least one facet oriented at an oblique angle to the two main faces.

19. The shaped ceramic abrasive grain as claimed in claim 1, wherein the shaped ceramic abrasive grain is based on alpha-Al₂O₃.

20. The shaped ceramic abrasive grain as claimed in claim 2, wherein the angle formed by the at least one facet to the adjoining one of the two main faces is from 140° to 150°.
